(19) United States
(12) Patent Application Publication
(10) Pub. No.: US 2009/0146650 A1
(43) Pub. Date: Jun. 11, 2009

(54) ROTATION ANGLE SENSOR AND SCISSORS GEAR SUITABLE THEREFOR

(75) Inventors: Shinji Hatanaka, Okazaki-shi (JP); Kenji Takeda, Okazaki-shi (JP); Shigetoshi Fukaya, Toyota-shi (JP); Naoki Nakane, Toyota-shi (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/331,796

(22) Filed: Dec. 10, 2008

(30) Foreign Application Priority Data
Dec. 11, 2007 (JP) 2007-319840
May 27, 2008 (JP) 2008-137996

(51) Int. Cl. G01B 7/30

(52) U.S. Cl. 324/207.25; 74/640

(57) ABSTRACT

A driving gear, which is a scissors gear, fixed to a rotating body, engages with a driven gear, and the driven gear engages with a fixed screw receiver. A first gear and a second gear of the driving gear elastically bias the tooth of the driven gear by a coil spring in the direction of an inner side of a diameter; consequently the driven gear 5 is forced on the screw receiver. Gears formed in the tooth tips of the driven gear engage with a partial spiral screw of the screw receiver.

### CROSS-REFERENCE TO RELATED APPLICATION

This application is based on and claims the benefit of priority from earlier Japanese Patent Application Nos. 2007-319840 and 2008-137996 filed Dec. 11, 2007 and May 27, 2008, respectively, the descriptions of which are incorporated herein by reference.

### BACKGROUND OF THE INVENTION

1. Technical field of the invention

The present invention relates to a rotation angle sensor that detects an angle of rotation of a rotary shaft by detecting the rotation of a magnetic field vector caused by the rotation of the rotary shaft, and also relates to a scissors gear suitable for the rotation angle sensor.

2. Description of the Related Art

Steering angle sensors utilizing a rotation angle sensor are known. Such a rotation angle sensor detects the change in the angle of rotation of a magnet (including a polarized body), using a magnetic sensing element.

Japanese Patent Laid-Open Publication No. 2005-003625 and U.S. Pat. No. 6,894,487 each disclose this type of rotation angle sensor which uses a sensor that can detect an angle of rotation greater than 360 degrees (hereinafter also referred to as an “over-360 degrees rotation sensor”) of a rotary shaft whose angle of rotation is to be detected. The term “over-360 degree rotation sensor” refers to a sensor that detects the total number of degrees of revolution that the rotary shaft has undergone. For example, on the first revolution a turn of 45 degrees from the rotation start point will be measured as 45 degrees. On the next revolution, the same position will be measured as 360+45 degrees, i.e. 405 degrees.

U.S. Pat. No. 6,894,487 suggests an over-360 degrees rotation sensor having a structure in which a magnet is rotated while being concurrently moved in the axial direction. A magnetic sensor that is disposed axially close to the magnet determines the angle of rotation based on the direction of the magnetic flux density and determines the Nth rotation (where N represents the number of complete rotations that have occurred since rotation started) based on the intensity of the magnetic flux density.

Scissors gears are also known. A scissors gear includes: two gears which are coaxially and relatively rotatably disposed, being adjacent to each other in the axial direction; and an elastic biasing member which is placed between the two gears to elastically bias the two gears in the directions mutually opposite to the rotating directions.

In the over-360 degrees rotation sensor suggested in Japanese Patent Laid-Open Publication No. 2005-003625, two magnet shafts independently engage with a single rotary shaft whose angle of rotation is to be detected. The angles of rotations of the two magnet shafts are detected by two respective magnetic sensing elements.

The two magnetic sensing elements are adapted to generate outputs having different phase angles. A signal processing unit then calculates an angle of rotation over 360 degrees based on the difference between the phase angles of the two outputs.

The over-360 degrees rotation sensor of this literature can detect an angle of rotation over 360 degrees. However, this sensor is required to arrange two sets of gear mechanisms, magnets and magnetic sensing elements around the rotary shaft subjected to detection.

Thus, the sensor disclosed in this literature has suffered from such problems as the increases in the number of parts and the size of the sensor, as well as the increase in the manufacturing cost.

A single-axis over-360 degrees rotation sensor explained below can mitigate these problems of the two-axis over-360 degrees rotation sensor.

The over-360 degrees rotation sensor disclosed in U.S. Pat. No. 6,894,487 needs a thrust movement mechanism, such as a screw mechanism or a gear mechanism, in order to ensure the axial movement of the magnet along the rotary shaft.

However, such a thrust movement mechanism has a complicated structure and requires a backlash to ensure smooth rotation. Because of the presence of such a backlash, the magnet unavoidably rattles in the axial direction with possible external vibration, for example. Accordingly, the determination of the Nth rotation of the magnet has been likely to be in error.

### SUMMARY OF THE INVENTION

The present invention has been made in light of the circumstances explained above, and has as its object to provide a single-axis over-360 degrees rotation sensor capable of preventing deterioration in the detection accuracy, which deterioration is ascribed to the rattling of the mechanism for rotating a magnet and for concurrently moving the magnet in the axial direction.

In the rotation angle sensor according to a first aspect, there is provided a rotation angle sensor comprises a gapped magnetic circuit that rotates interlocking with a rotation of a rotating body, a magnetic sensing element that senses a gapped magnetic flux of the gapped magnetic circuit, and a signal processing unit that outputs the angle of the rotating body by processing a signal from the magnetic sensing element, wherein, the gapped magnetic circuit produces a flux that changes its direction and size by the rotation of the rotating body to the magnetic sensing element so that an angle of rotation greater than 360 degrees of the rotating body is detected.

A rotation angle sensor further comprises a driving gear that is fixed to the rotating body, a driven gear having a thread groove on its tooth tips that engages to the driving gear and integrates the gapped magnetic circuit therein, and a magnet and a yoke, a screw receiver that engages to the thread groove of the driven gear so that the driven gear is displaced in its axial direction by the rotation of the driven gear, and a housing that supports the screw receiver and the magnetic sensing element.

In addition, the driving gear is made up of a scissors gear that are constituted of two gears that are coaxially and relatively rotatably disposed, being adjacent to each other in the axial direction, and having an elastic biasing member that elastically biases the two gears in the directions mutually opposite to the rotating directions, wherein, the screw receiver is arranged at a position that regulates the displacement which separates the driven gear from the driving gear by a force applied against the driven gear caused by the elastic biasing member.

Similar to the sensor of U.S. Pat. No. 6,894,487, the rotation angle sensor of the invention uses the driving mechanism in which the gapped magnetic circuit having the magnet is rotated and concurrently moved in the axial direction with the rotation of the rotating body Thus, the sensor can be applied to the single-axis over-360 degrees rotation sensor that determines an angle of rotation based on the magnetic field detected by the magnetic sensing element in a non-contact manner, and determines the N^{th} rotation based on the intensity of the magnetic field.

A cylindrical body having a substantially cylindrical shape with a cut away portion extending in the axial direction that has a female spiral thread face in the inner surface can configure the screw receiver. Preferably, the two gears configuring the driving gear serving as a scissors gears may have the same number of teeth.

The driving mechanism includes the driving gear fixed to the rotating body, and includes the driven gear rotated by the driving gear. The gapped magnetic circuit is incorporated into the driven gear. The gapped magnetic circuit includes the permanent magnet and the yoke.

The magnetic flux of the permanent magnet passes, via the yoke, through the magnetic sensing element that is provided at the gap of the magnetic circuit. Thus, the direction of the magnetic flux that passes through the magnetic sensing element changes with the rotation of the gapped magnetic circuit.

Meanwhile, the magnetic sensing element can detect the angle of rotation of the rotating body by detecting the direction of the magnetic field.

Further, the driving mechanism includes the screw receiver fixed to the housing. The screw receiver has a face that engages with each tooth tip of the driven gear. Thus, the driven gear is guided to the spiral thread face of the screw receiver as it is rotated and axially displaced, that is, the gapped magnetic circuit is axially displaced with the rotation of the rotating body.

The gapped magnetic circuit has a structure that allows monotonous changes in the intensity of the magnetic field imparted to the magnetic sensing element, with the axial displacement of the gapped magnetic circuit.

Accordingly, the N^{th} rotation of the rotating body can be detected based on the intensity of the magnetic field detected by the magnetic sensing element.

The present invention has a feature, in particular, that the driving gear is made up of a scissors gear and that the screw receiver is located at a position which is applied with a bias force against the driven gear, which bias force is caused by the elastic biasing member of the scissors gear.

This configuration permits the two driving gears of the scissors gear to sandwich the teeth of the driven gear to eliminate the backlash between the scissors gear and the driven gear. At the same time, the backlash between the driven gear and the screw receiver can also be eliminated because the elastic biasing member of the scissors gear pushes the driven gear against the screw receiver.

Thus, deterioration in the detection accuracy can be prevented, which deterioration would have been caused by mechanical backlash in the driving mechanism, to thereby realize the high-accuracy over-360 degrees rotation sensor.

In the rotation angle sensor according to a second aspect, the screw receiver is substantially arranged at the opposite side of the drive gear sandwiching the driven gear there between.

The term “substantially” here refers to an angle less than 10 degrees centering on the axis of the driven gear, with reference to the line extended from the line that connects the axis of the rotating body and the axis of the driven gear. Thus, the driven gear can be favorably pushed against the screw receiver, using the bias force of the driving gear, or the scissors gear, against the driven gear.

In the rotation angle sensor according to a third aspect, the elastic biasing member is constituted of a coil spring having two ends arranged on the same straight line that passes through the center axis of the driving gear in the state where the coil spring is fixed to the driving gear.

Thus, noise can be reduced, which is induced by the gears configuring the non-backlash gear, or by the gear and the spring.

In the rotation angle sensor according to a fourth aspect, angles of the two ends of the elastic biasing member are set to less than 90 degrees in the state where the elastic biasing member is fixed to the driving gear.

Thus, noise can be reduced, which is induced by the gears configuring the non-backlash gear, or by the gear and the spring.

In a preferred embodiment, the magnetic sensing element is located on the axis of the driven gear and positioned for detecting the magnetic field components in the radial direction of the driven gear.

In a preferred embodiment, the gapped magnetic circuit having the magnet and the yoke forms a unidirectional magnetic field on the axis of the driven gear, or a gap, so as to be perpendicular to the axis.

Further, the gapped magnetic circuit has a structure that allows the intensity of the magnetic field imparted to the magnetic sensing element on the axis of the driven gear to change, according to the changes in the axially relative distance between the circuit and the magnetic sensing element.

Preferably, the driven gear may have in the inside thereof a pair of polarized areas that face with each other interposed by the axis, and the magnetic flux between the pair of polarized areas may pass through the magnetic sensing element. The pair of polarized areas is tapered in the axial cross section.

Thus, the radial distance from the magnetic sensing element to each polarized area (corresponding to one half of the radial gap length between the poles) changes with the rotation of the pair of polarized areas, i.e. the rotation of the driven gear.

In other words, the rotation of the driven gear causes a change in the distance between the poles positioned radially lateral sides of the magnetic sensing element, and the change then causes another change in the magnetic field passing through the magnetic sensing element.

Accordingly, the number of rotations of the driven gear can be determined based on the intensity of the magnetic field detected by the magnetic sensing element.

In a preferred embodiment, two magnetic sensing elements are used, which are located perpendicular to each other. The angle of rotation of the driven gear is detected based on the ratio of the signals detected by the two magnetic sensing elements.

Specifically, the magnetic field acting on the two magnetic sensing elements in a static condition sinusoidally changes as the driven gear is rotated. In the end, an angle of rotation θ of 360 degrees or less is calculated from an “arctan” value that is a detected angle of the driven gear. The calculated value is then added to a value of “number of rotation θ of 360 degrees” to calculate a final angle of rotation of the driven gear, the resultant of which may then be substituted with the angle of rotation of the rotating body (which angle is also referred to as a “turn angle”).

As to these signal processings, refer to Japanese Patent Laid-Open Publication Nos. 2007-256250, 2007-263585 and 2007-309681, filed by the applicant of the present invention.

In the rotation angle sensor according to a fifth aspect, a rotation angle sensor further comprises a driving gear that is fixed to the rotating body, a driven gear having a thread groove on its tooth tips that engages to the driving gear and integrates the gapped magnetic circuit therein, and a magnet and a yoke, a screw receiver that engages to the thread groove of the driven gear so that the driven gear is displaced in its axial direction by the rotation of the driven gear, a housing that supports the magnetic sensing element, and an elastic biasing member supported by the housing that elastically biases the screw receiver to the rotating body.

Thus, the elastic biasing member can reduce not only the backlash between the thread of the screw receiver and the teeth of the driven gear, but also the backlash between the teeth of the driven gear and the teeth of the driving gear. Moreover, the accuracy of detecting the angle of rotation can be enhanced with this simple structure.

In the rotation angle sensor according to a sixth aspect, the two gears of the scissors gear have an identical shape.

Thus, the number of parts can be reduced, and the manufacturing processes can be simplified.

In the rotation angle sensor according to a seventh aspect, two gears are coaxially and relatively rotatably disposed, being adjacent to each other in the axial direction, and an elastic biasing member is provided in the two gears that elastically biases the two gears in the directions mutually opposite to the rotating directions, wherein the two gears have an identical shape.

Thus, the number of parts can be reduced, and the manufacturing processes can be simplified.

### BRIEF DESCRIPTION OF THE DRAWINGS

In the accompanying drawings:

FIG. 1 is a schematic axial cross-sectional view illustrating a principal part of a steering angle sensor according to a first embodiment of the present invention;

FIG. 2 is a schematic plane view illustrating the principal part of the sensor illustrated in FIG. 1;

FIG. 3 illustrates rotation angles “φ” and “θ” relative to X-direction magnetic flux density component “Bx” and Y-direction magnetic flux density component “By”;

FIG. 4 is a schematic view illustrating an engaged state between a driving gear and a driven gear;

FIG. 5 is a schematic view illustrating an engaged state between the driven angle and a screw receiver;

FIG. 6A illustrates a coil spring as viewed from an axial direction;

FIG. 6B is a side view illustrating the coil spring as viewed from the direction indicated by an arrow “A” in FIG. 6A;

FIG. 6C a side view illustrating the coil spring as viewed from the direction indicated by an arrow “B” in FIG. 6A;

FIG. 7A illustrates a modification of a coil spring as viewed from an axial direction;

FIG. 7B is a side view illustrating the coil spring of FIG. 7A;

FIG. 8A illustrates a modification of a coil spring as viewed from an axial direction;

FIG. 8B is a side view illustrating the coil spring of FIG. 8A;

FIG. 9 is a schematic axial cross-sectional view illustrating a principal part of a steering angle sensor according to a second embodiment of the present invention;

FIG. 10A is a plane view illustrating a driving gear used for a steering angle sensor according to a third embodiment of the present invention;

FIG. 10B is an axial cross-sectional view illustrating the driving gear of FIG. 10A;

FIG. 11A is an axial cross-sectional view illustrating only a first gear of the gear illustrated in FIGS. 10A and 10B; and

FIG. 11B illustrates the first gear of FIG. 11A as viewed from the direction indicated by an arrow “A” in FIG. 11A.

### DETAILED DESCRIPTION OF THE PREFERRED EMBODIMENTS

With reference to the accompanying drawings, hereinafter will be described some embodiments of a steering angle sensor to which a rotation angle sensor of the present invention is applied.

It should be appreciated that the present invention is not limited to the embodiments provided below, but the technical idea of the present invention may be realized in combination with other techniques.

### First Embodiment

### (Configuration)

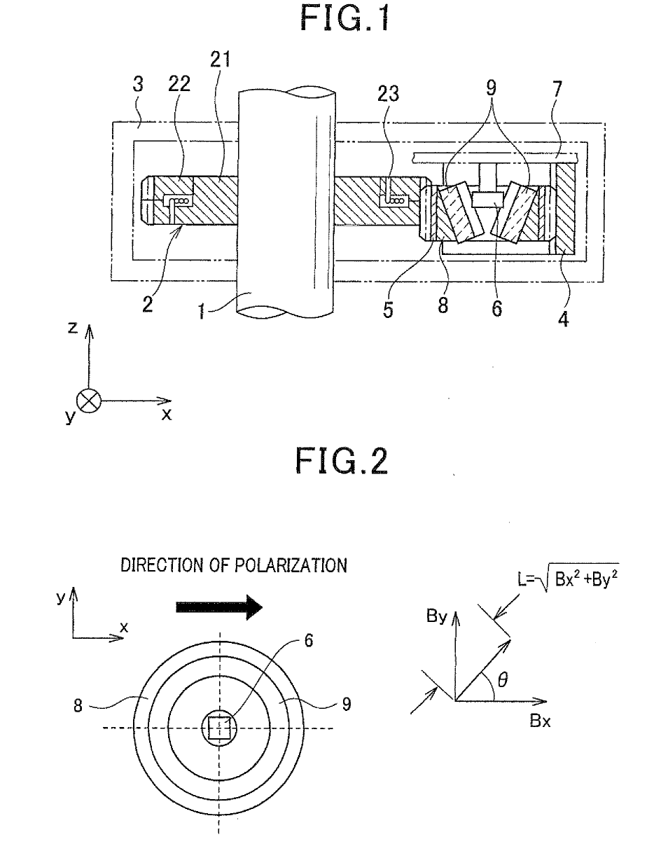

Referring to FIG. 1, hereinafter is described a steering angle sensor according to a first embodiment. FIG. 1 is a schematic cross-sectional view illustrating the sensor, and FIG. 2 is a plane view illustrating a principal part of the sensor.

The steering angle sensor is a sensor for detecting an angle of rotation of a rotating body 1 that configures a steering shaft. The rotating body 1 is fixed with a driving gear 2 serving a scissors gear. The rotating body 1 is disposed passing through a housing 3.

A screw receiver 4 is fixed to an area of an inner peripheral surface of the housing 3. A driven gear 5 is disposed being engaged with the driving gear 2 and the screw receiver 4. A magnetic sensing element 6 is disposed being vertically hung from the housing 3 toward an axis of the driven gear 5.

The sensor also includes a circuit board 7 on which an electronic circuit, i.e. a signal processing unit (not shown), of the present invention is mounted.

The driving gear 2 is made up of a scissors gear which is a so-called “non-backlash gear”. The details of the driving gear 2 will be described later

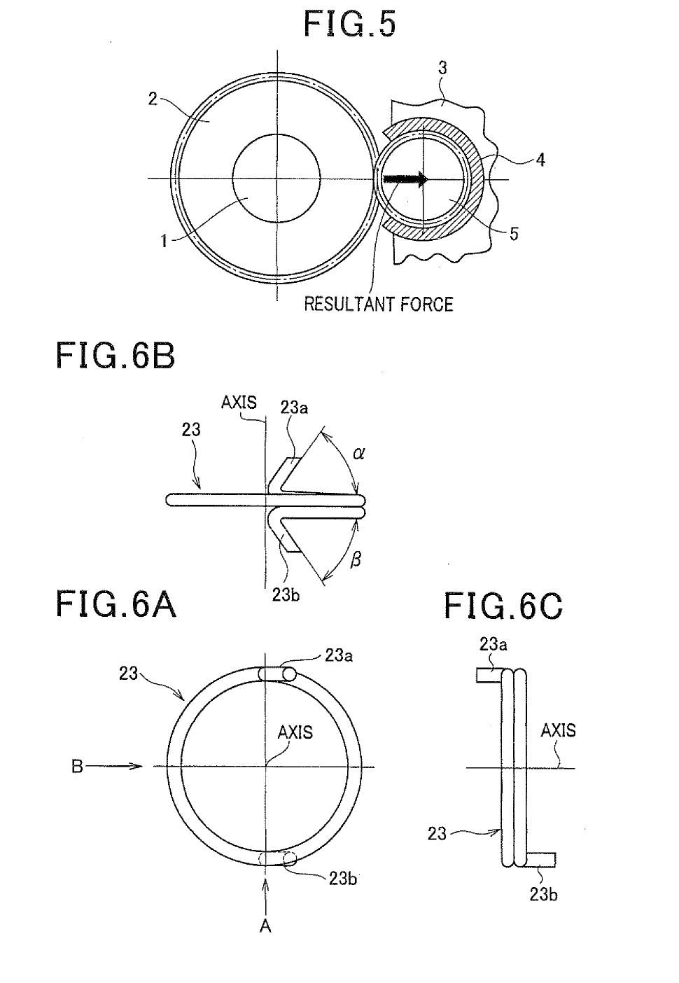

The screw receiver 4 has a cylindrical body having a substantially cylindrical shape with a cut away portion extending in the axial direction (refer to FIG. 5). The screw receiver 4 having the cylindrical shape with the cut away portion is obtained by axially cutting off a portion of a cylindrical body by a predetermined angular width, the cylindrical body having an inner peripheral surface in which a spiral thread face is formed.

Accordingly, the spiral thread face formed in the inner peripheral surface of the screw receiver 4 is also has a cylindrical shape with a cut away portion.

The driven gear 5 is interposed between the rotating body 1 and the screw receiver 4, with its axis being positioned on an imaginary linear line connecting the axis of the rotating body 1 and the circumferential center of the screw receiver 4.

The driven gear 5 is engaged with the driving gear 2, i.e. a scissors gear. In addition, the driven gear 5 has tooth tips, each of which is formed with a thread groove for engagement with the partially lacked incomplete spiral thread face of the screw receiver 4. The driven gear 5 is rotatably arranged at an upper surface of a bottom portion of the housing 3.

The driven gear 5 has a cylindrical shape, with its inner peripheral surface being fixed with a cylindrical soft magnetic yoke 8. The yoke 8 has a tapered inner peripheral surface into which a polarized cylindrical permanent magnet 9 is fitted for fixation.

The soft magnetic yoke 8 and the polarized permanent magnet 9 configure a gapped magnetic circuit of the invention. The inner peripheral surface of the cylindrical yoke 8 forms a truncated cone having a tapered cross section, as shown in FIG. 1.

The cylindrical permanent magnet 9 is shaped so that its outer peripheral surface can be closely in contact with the inner peripheral surface of the yoke 8, and has an even radial thickness throughout the magnet.

As a result, the inner peripheral surface of the cylindrical permanent magnet 9 also forms a truncated cone having a tapered cross section, as shown in FIG. 1.

It should be appreciated that the yoke 8 and the driven gear 5 may be formed in integration and the cylindrical permanent magnet 9 may be made up of two permanent magnets, being arranged apart from each other by 180 degrees

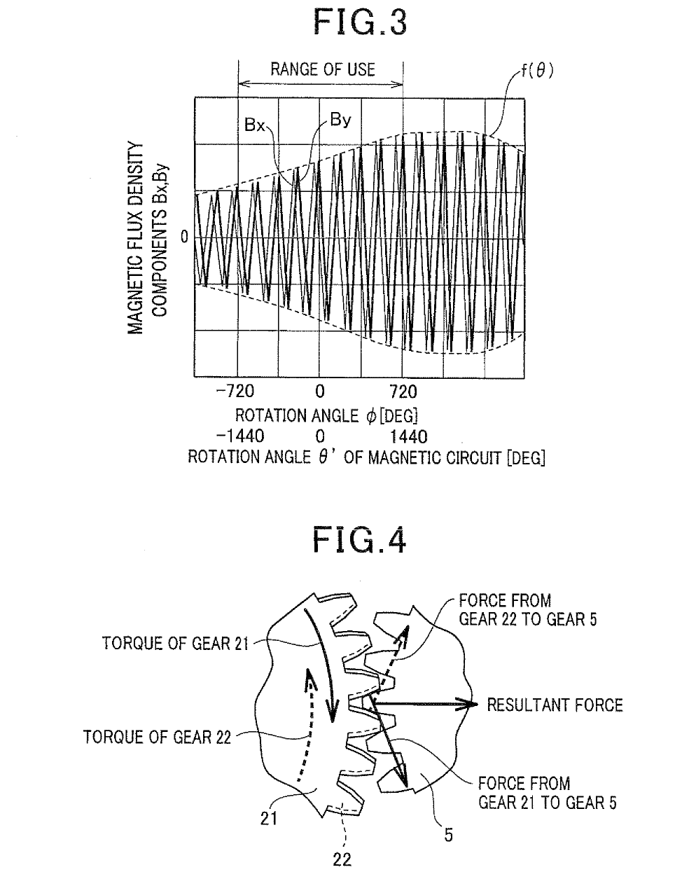

As shown in FIG. 3, the cylindrical permanent magnet 9 is unidirectionally polarized in a predetermined manner in its radial cross section. As a result, N- and S-pole areas (a pair of polarized areas) are formed in the inner peripheral surface of the permanent magnet 9 on both sides of the unidirection.

The pair of polarized areas forms radially unidirectional magnetic fields in a space (gap) of the cylindrical permanent magnet 9. The yoke 8 establishes magnetic connection between the polarized areas to provide a magnetic path to which magnetic flux that has flowed through the space returns.

Specifically, referring to FIG. 2, the magnet 9 is polarized in an X-direction. In FIG. 2, magnetic flux Φ having a certain density (hereinafter just referred to as “magnetic flux Φ”) is formed in the X-direction at the position of the magnetic sensing element 6.

It should be appreciated that X and Y indicate two directions that are perpendicular to each other. The magnetic flux Φ that radially passes through the magnetic sensing element 6 is decomposed into a Bx component that is a flux density component in the X-direction, and By component that is a flux density component in the Y-direction.

The magnetic sensing element 6 is incorporated with a semiconductor chip that is an integration of two Hall elements and peripheral circuits for the Hall elements. One Hall element outputs a signal voltage Vx proportionate to the X-direction flux density component Bx, and the other Hall element outputs a signal voltage Vy proportionate to the Y-direction flux density component By.

### (Operation)

Hereinafter is described an angle of rotation sensing operation of the sensor described above.

When the driving gear 2 rotates with the rotating body 1, the driven gear 5 in engagement with the driving gear 2 is rotated. Being in engagement with the screw receiver 4, the driven gear 5 is axially displaced while being concurrently rotated.

With the rotation of the rotating body 1, the pair of polarized areas rotates, while at the same time, the radial distance between each of the pair of polarized areas and the magnetic sensing element 6 successively changes.

As a result, with the rotation of the rotating body 1, the direction and the intensity of the magnetic field (which may be considered as being magnetic flux having certain density) radially passing through the magnetic sensing element 6 is successively altered.

When a rotation angle of the permanent magnet 9 is “θ” with reference to the X-direction, the X-direction flux density component Bx and the Y-direction flux density component By imparted to the magnetic sensing element 6 by the magnet 9 are expressed as follows.

Bx=f(θ)cos θ

By=f(θ)sin θ

It should be appreciated that f(θ) is a function that indicates the change in a vector length L of the magnetic flux Φ at the position of the magnetic sensing element 6, which change is caused by the axial displacement of the magnet 9. The function value f(θ) is determined, for example, by the shapes and the materials of the magnet and the yoke.

A signal processing unit, not shown, stores the relationship between the function value f(θ) indicative of the vector length L of the flux density B and the number of rotations of a magnet rotation axis.

The signal processing unit has a function of conducting inverse tangent calculation for the flux density components Bx and By inputted from the magnetic sensing element 6. As a result of the inverse tangent calculation, a relation expressed by:

θ=arctan(By/Bx)

is obtained. Thus, angular information within 360 degrees of the permanent magnet 9 can be obtained from the rotation angle θ. Further, the signal processing unit has a function of calculating a square root of, sum of the squared flux density components Bx and By. Using this calculation, the vector length L of the magnetic flux Φ can be obtained.

Based on the function value f(θ) indicative of the vector length L of the magnetic flux Φ and the relationship stored in the processing unit, the number of rotations of the magnet rotation axis is calculated.

In other words, in the present embodiment, calculation is made as to the N^{th} rotation starting from the axial reference position based on the value f(θ), calculation is made as to the present-time rotation angle θ based on the value of arctan (By/Bx), and calculation is made as to a rotation angle θ′ of 360 degrees or more based on the values derived from the foregoing calculations.

For example, if the second rotation is being made currently, and the rotation angle θ is 55 degrees, the final rotation angle θ′ is calculated as being 415 degrees (360 degrees+55 degrees) and outputted.

FIG. 3 shows a relationship between the rotation angle φ of the rotating body 1, the rotation angle θ′ of the permanent magnet 9, and the flux density components Bx and By at the position of the magnetic sensing element 6.

Specifically, according to the present embodiment, an angle of rotation of 360 degrees or more can be detected using one set of rotating angle assembly, by rotating the magnet with the concurrent axial displacement of the magnet.

### (Explanation on the Driving Gear 2)

Referring now to FIGS. 4 and 5, hereinafter is provided a more detailed explanation on the driving gear 2 that is characteristic of the present embodiment.

The drive gear 2 includes a first gear 21 fitted and fixed to the rotating body 1, a second gear 22 disposed being axially adjacent to the first gear 21, and a coil spring 23. The second gear 22 is loosely fitted to the rotating body 1 or the first gear 21, while being elastically biased in one circumferential direction with respect to the first gear 21 by the coil spring 23.

The first and second gears 21 and 22 have the same number of teeth and substantially the same shape, and sandwich the driven gear 5 therebetween. In FIG. 4, the first and second gears 21 and 22 are indicated by solid line and dotted lines, respectively.

Thus, as shown in FIG. 4, the coil spring 23 elastically biases the second gear 22 in the direction opposite to the direction of the torque (direction of rotation) of the driving gear 2, so that the resultant force is applied to the teeth of the driven gear 5 in the radially inward direction.

The resultant force is transferred to the screw receiver 4 via the driven gear 5 which can be displaced within the radial plane. As a result, the backlash is eliminated from between a spiral thread face in each tooth tip of the driven gear 5 and the spiral thread face of the screw receiver 4.

### (Shape of the Coil Spring 23)

Referring to FIGS. 6A to 6C, hereinafter is described the shape of the coil spring 23 which is disposed in an axial gap between the first and second gears 21 and 22.

One end 23a of and the other end 23b of the coil spring 23 are oriented to the same tangent direction of the coil spring 23 (see FIG. 6A), and at the same time, projected to the directions axially opposite to each other (see FIG. 6C). Also, the ends 23a and 23b of the coil spring 23 have inclination angles α and β, respectively, with respect to the radial direction in the axially cross-sectional plane.

When the inclination angles α and β are both 90 degrees, the first and second gears 21 and 22 are applied with a force in the direction of rotation by the coil spring 23, but will be caused no force in the axial direction. Therefore, when vibration is axially inputted, the first and second gears 21 and 22 are likely to be impulsively brought into contact with each other to cause noise.

In this regard, as shown in FIGS. 6A to 6C, the present embodiment sets the angles α and β to be less than 90 degrees when the coil spring 23 is used in its winding direction, and to be more than 90 degrees when the coil spring 23 is used in its unwinding direction.

Thus, in addition to the elastically biasing force in the direction of rotation, the coil spring 23 can apply a force that will permit the first and second gears 21 and 22 to pull each other in the axial direction.

In this way, the possible occurrences of noise can be eliminated, which noise would otherwise have been caused by the impulsive contact between the first and second gears 21 and 22.

### (Modifications)

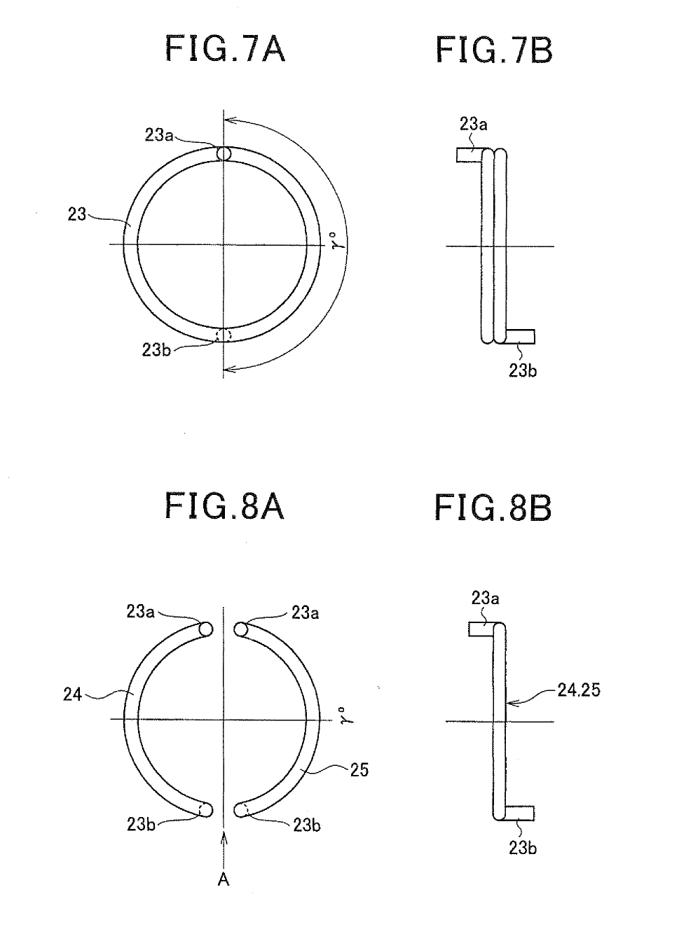

Hereinafter, a modification is described referring to FIGS. 7A and 7B. In the present modification, the identical or similar components to those in the first embodiment described above are given the same reference numerals for the sake of omitting explanation.

In the present modification, a circumferential angle y between the ends 23a and 23b of the coil spring 23 is fixed to about 180 degrees. With this angle, the center of gravity of the coil spring 23 falls on the vicinity of the center between the ends 23a and 23b of the coil spring 23, ensuring the stability of the coil spring 23.

For example, setting the value of γ to 0 degree will permit the coil spring 23 to easily vibrate with the external vibration. As a result, the coil spring 23 will be impulsively brought into contact with the first and second gears to cause noise.

This problem can be favorably mitigated by setting the circumferential angle to about 180 degrees, between the ends 23a and 23b of the coil spring 23. In this way, the coil spring 23 can be favorably prevented from being vibrated by the external vibration that would have caused the noise mentioned above.

Needless to say, the two-turn coil spring 23 shown in FIGS. 7A and 7B may be replaced by two substantially semi-perimetric coil springs 24 and 25 as shown in FIGS. 8A and 8B.

It should be appreciated that the “angle γ” mentioned above is intended to mean an angle after the incorporation of the coil spring 23 into the sensor by applying a force for winding or unwinding the coil spring.

### (Advantages)

As described above, the elastically biasing force of the spring of the driving gear 2 serving as a scissors gear can eliminate the backlash between the driving gear 2 and the driven gear 5, as well as the backlash between the driven gear 5 and the screw receiver 4, whereby high-accuracy can be ensured in detecting the angle of rotation.

In other words, the resulting force derived from the non-backlash-gear function of the driving gear 2 can eliminate the backlash between the driven gear 5 and the screw receiver 4. In this way, the accuracy can be ensured in detecting an angle of rotation under the conditions where external forces or vibrations are estimated to be large, such as in a motor vehicle.

### Second Embodiment

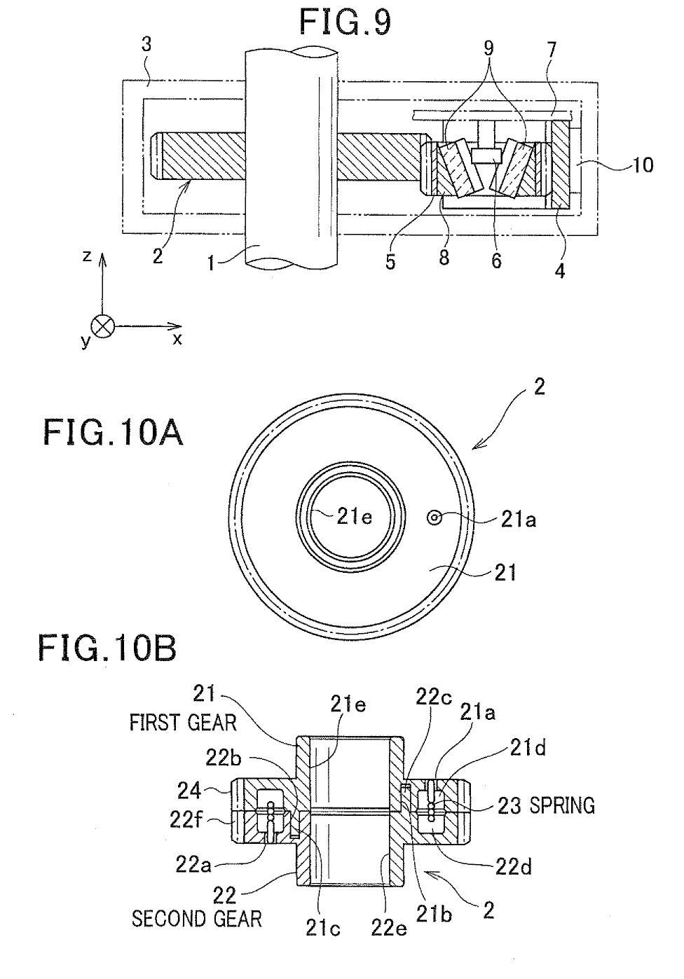

Hereinafter is described a second embodiment of the present invention referring to FIG. 9. In the present and the subsequent embodiments, the identical or similar components to those in the first embodiment described above are given the same reference numerals for the sake of omitting explanation.

The present embodiment is different from the first embodiment shown in FIG. 1 in that the driving gear 2 is configured by a simple single gear and that a leaf spring member 10 is interposed between the bottom surface, or the outer peripheral portion, of the screw receiver 4 and the inner peripheral surface of the housing 3, so that the screw receiver 4 can be elastically biased to the side of the rotating body 1 via the driven gear 5.

In this case as well, the driven gear 5 should be held by the housing 3 in a manner of enabling displacement in the radial direction of the rotating body 1.

With this configuration, the leaf spring member 10 serving as an elastic biasing member can apply an elastically biasing force in the direction that can eliminate the backlash between the screw receiver 4 and the driven gear 5, concurrently with the elimination of the backlash between the driven gear 5 and the driving gear 2.

Thus, high accuracy can be ensured in detecting an angle of rotation, using the simple configuration.

### Third Embodiment

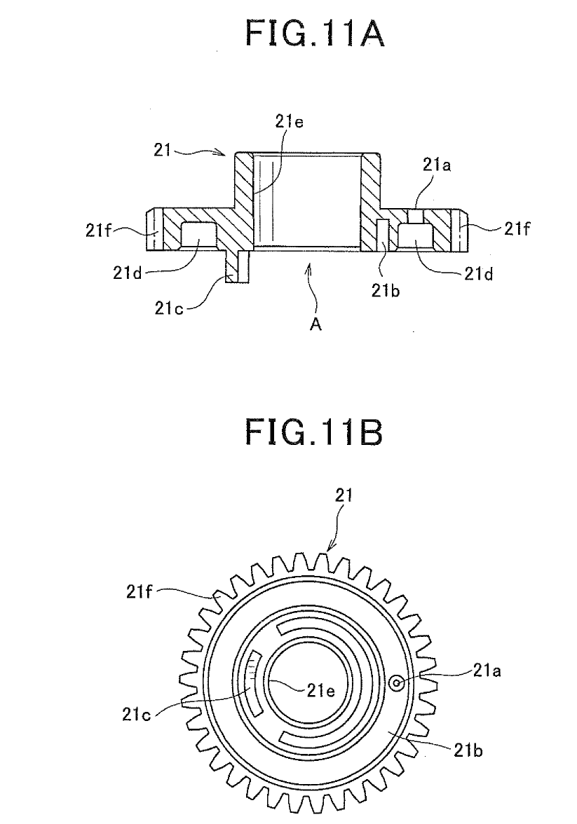

With reference to FIGS. 10A to 11B, hereinafter is described a third embodiment of the present invention.

The present embodiment is different from the first embodiment shown in FIG. 1 in that the shape has been changed in each of the first and second gears 21 and 22 that configure the scissors gear, i.e. the driving gear 2.

Referring to FIGS. 10A to 11B, the driving gear 2 of the present embodiment is described in detail. FIG. 10A is a plane view illustrating the driving gear 2 and FIG. 10B is an axial cross-sectional view of the driving gear 2.

FIG. 11A is an axially cross-sectional view illustrating only the first gear 21, and FIG. 11B illustrates the first gear 21 as viewed from the direction indicated by an arrow “A” in FIG. 11A.

The driving gear 2 includes the first gear 21, the second gear 22 which is axially adjacent to the first gear 21, and the coil spring 23. The first and second gears 21 and 22 are axially fitted to each other to configure the driving gear 2. The present embodiment has a feature in that the first and second gears 21 and 22 are fabricated to have an identical figure.

The first and second gears 21 and 22 each have a cylindrical portion and a disk portion that radially extends from the end of the cylindrical portion, so that a flanged shape can be formed as a whole. The disk portions of the first and second gears 21 and 22 are axially adjacent to each other.

The first gear 21 has a through hole 21a for engaging the spring, an arc-shaped fitting groove 21b, an arc-shaped fitting projection 21c, a ring-shaped spring accommodating groove 21d, a shaft hole 21e into which the rotating body 1 is fittingly inserted, and a gear portion 21f.

The through hole 21a and the spring accommodating groove 21d are formed in the disk portion, the through hole 21a being provided at the bottom portion of the spring accommodating groove 21d.

The arc-shaped fitting groove 21b and the arc-shaped fitting projection 21c are provided being close to the radially outer side of the spring accommodating groove 21d. The circumferential centers of the fitting groove 21b and the fitting projection 21c are formed at positions circumferentially opposite to each other by about 180 degrees. The rotating body 1 is inserted to fit snugly into the shaft hole 21e.

Similarly, the second gear 22 has a through hole 22a for engaging the spring, an arc-shaped fitting groove 22b, an arc-shaped fitting projection 22c, a ring-shaped spring accommodating groove 22d, a shaft hole 22e into which the rotating body 1 is fittingly inserted, and a gear portion 22f.

The through hole 22a and the spring accommodating groove 22d are formed in the disk portion, the through hole 22a being provided at the bottom portion of the spring accommodating groove 22d.

The arc-shaped fitting groove 22b and the arc-shaped fitting projection 22c are provided being close to the radially outer side of the spring accommodating groove 22d. The circumferential centers of the fitting groove 22b and the fitting projection 22c are formed at positions circumferentially opposite to each other by about 180 degrees. The rotating body 1 is fittingly inserted into the shaft hole 22e.

The end faces of the disk portions of the coaxially located first and second gears 21 and 22 are in contact with each other. The fitting projection 21c is fitted to the fitting groove 22b, and the fitting projection 22c is fitted to the fitting groove 21b.

The ring-shaped spring accommodating grooves 21d and 22d are axially aligned with each other with the spring 23 being accommodated therein. One end of the spring 23 is engaged with the through hole 21a and the other end is engaged with the through hole 22a.

The driving gear 2 serving as a scissors gear is formed by rotating the first and second gears 21 and 22 of an identical shape by 180 degrees and then bringing the disk portions of the gears into axial alignment. Except that the first and second gears 21 and 22 have an identical shape, other characteristic configurations and operations of the driving gear 2 are the same as those of the driving gear 2 of the first embodiment.

To serve as a scissors gear, the spring 23 biases the first and second gears 21 and 22 in the opposite directions with rotations to thereby eliminate the backlash of the driving gear 2.

### (Modification)

In the above description, the driving gear 2 in the rotation angle sensor has been made up of the first and second gears 21 and 22 having an identical shape. The scissors gear made up of the two identically shaped gears can be used for devices other than the rotation angle sensor.

### Advantages of the Embodiments

Comparing with the first and second gears 21 and 22 having different shapes shown in FIG. 1, the first and second gears 21 and 22 of the embodiment shown in FIGS. 10A to 11B have an identical shape.

Thus, the latter can be more easily manufactured, significantly reduce the number of processes, and simplify the manufacturing equipment. In particular, the reduction in the cost of the mold can realize significantly large reduction in the manufacturing cost.

Moreover, permitting the fitting projection 21c to fit into the fitting groove 22b, and permitting the fitting projection 22c to fit into the fitting groove 21b can reinforce the fitting between the first and second gears 21 and 22. Accordingly, owing to the reinforced fitting, the driving gear 2 can be easily held and thus the assembling operation can be facilitated.

What is claimed is:

1. A rotation angle sensor comprising:
a gapped magnetic circuit that rotates interlocking with a rotation of a rotating body;
a magnetic sensing element that senses a gapped magnetic flux of the gapped magnetic circuit; and
a signal processing unit that outputs the angle of the rotating body by processing a signal from the magnetic sensing element;
wherein, the gapped magnetic circuit produces a flux that changes its direction and size by the rotation of the rotating body to the magnetic sensing element so that an angle of rotation greater than 360 degrees of the rotating body is detected;
a rotation angle sensor further comprising:
a driving gear that is fixed to the rotating body;
a driven gear having a thread groove on its tooth tips that engages to the driving gear and integrates the gapped magnetic circuit therein, and a magnet and a yoke;
a screw receiver that engages to the thread groove of the driven gear so that the driven gear is displaced in its axial direction by the rotation of the driven gear; and
a housing that supports the screw receiver and the magnetic sensing element;
the driving gear is made up of a scissors gear that is constituted of two gears that are coaxially and relatively rotatably disposed, being adjacent to each other in the axial direction, and having an elastic biasing member that elastically biases the two gears in the directions mutually opposite to the rotating directions;
wherein, the screw receiver is arranged at a position that regulates the displacement that separates the driven gear from the driving gear by a force applied against the driven gear caused by the elastic biasing member.

2. A rotation angle sensor of claim 1,
wherein the screw receiver is substantially arranged at the opposite side of the drive gear sandwiching the driven gear there between.

3 A rotation angle sensor of claim 1,
wherein the elastic biasing member is constituted of a coil spring having two ends arranged on the same straight line that passes through the center axis of the driving gear in the state where the coil spring is fixed to the driving gear.

4. A rotation angle sensor of claim 1,
wherein angles of the two ends of the elastic biasing member are less than 90 degrees in the state where the elastic biasing member is fixed to the driving gear.

5. A rotation angle sensor comprising:
a gapped magnetic circuit that rotates interlocking with a rotation of a rotating body;
a magnetic sensing element that senses a gapped magnetic flux of the gapped magnetic circuit; and
a signal processing unit that outputs an angle of the rotating body by processing a signal from the magnetic sensing element;
wherein, the gapped magnetic circuit produces a flux that changes its direction and size by a rotation of the rotating body to the magnetic sensing element so that an angle of rotation over 360 degrees of the rotating body is detected;
a rotation angle sensor further comprising:
a driving gear that is fixed to the rotating body;
a driven gear having a thread groove on its tooth tips that engages to the driving gear and integrates the gapped magnetic circuit therein, and a magnet and a yoke;
a screw receiver that engages to the thread groove of the driven gear so that the driven gear is displaced in its axial direction by the rotation of the driven gear;
a housing that supports the magnetic sensing element; and
an elastic biasing member supported by the housing that elastically biases the screw receiver to the rotating body.

6. A rotation angle sensor of claim 1,
wherein the two gears of the scissors gear have an identical shape.

7. A rotation angle sensor of claim 6,
the two gears are arranged facing each other and each has a groove and a fitting projection which fit in mutually at approximately the same diameter position, permitting relative rotation of a predetermined angle.

8. A scissors gear comprising:
two gears are coaxially and relatively rotatably disposed, being adjacent to each other in the axial direction; and
an elastic biasing member is provided in the two gears that elastically biases the two gears in the directions mutually opposite to the rotating directions;
wherein the two gears have an identical shape.

9. A scissors gear of claim 8,
the two gears are arranged facing each other and each has a groove and a fitting projection which fit in mutually on the approximately the same diameter position, permitting relative rotation of a predetermined angle.
